(19) United States
(12) Patent Application Publication
(10) Pub. No.: US 2022/0129413 A1
(43) Pub. Date: Apr. 28, 2022

(54) ELECTRONIC FILE MIGRATION SYSTEM AND METHODS OF PARTITIONING MIGRATED DATA BETWEEN STORAGE SYSTEMS

(71) Applicant: KOMPRISE INC., CAMPBELL, CA (US)

(72) Inventors: MICHAEL PEERCY, CAMPBELL, CA (US); KUMAR GOSWAMI, CAMPBELL, CA (US); MOHIT DHAWAN, CAMPBELL, CA (US)

(21) Appl. No.: 17/504,995

(22) Filed: Oct. 19, 2021

Related U.S. Application Data
(60) Provisional application No. 63/104,300, filed on Oct. 22, 2020.

(51) Int. Cl. G06F 16/11; G06F 16/16; G06F 16/182

(52) U.S. Cl. CPC G06F 16/119; G06F 16/182; G06F 16/162

(57) ABSTRACT

An electronic file migration system has a processor. A memory is coupled to the processor, the memory storing program instructions that when executed by the processor, causes the processor to: migrate files from a first storage system to a second storage system, wherein a first set of files are copied as completed files to the second storage system and a second set of files have symbolic links written on the second storage system directed to the second set of files stored on the first storage system.

### RELATED APPLICATIONS

This patent application is related to U.S. Provisional Application No. 63/104,300 filed Oct. 22, 2020, entitled “ELECTRONIC FILE MIGRATION SYSTEM AND METHODS OF PARTITIONING MIGRATED DATA BETWEEN STORAGE SYSTEMS” in the name of the same inventors, and which is incorporated herein by reference in its entirety. The present patent application claims the benefit under 35 U.S.C § 119(e).

### TECHNICAL FIELD

The present application generally relates to network-based data backup and migration systems and methods, and, more specifically, to cloud-based client platform-agnostic electronic file migration systems and various methods of transparent data migration and access management.

### BACKGROUND

Modern information technology (IT) data management involves organizing, transferring, and storing a vast amount of ever-increasing accumulation of data across multiple data storages in various locations. Multiple data storages in various locations typically involve on-premise (i.e., onsite or localized) computerized data storages, offsite cloud-computing data storages, or a combination of both. Conventional IT data management also involves various application-specific and/or client-specific data management tools across different computing platforms, protocols, operating systems, and storage locations. These conventional data management tools often lack seamless interoperability and cause “information silos” (i.e., interoperability deficiency) in a corporate data management department.

Furthermore, conventional IT data management faces a daunting challenge in handling an ever-growing list of data storage and computer server resources for data backups and file migrations. Conventional IT data management solutions are not fully vendor-agnostic and tend to rely on hardware-specific conditions and parameters, which make data management less flexible, cumbersome, and often inefficient with wasted resources. A poor and ineffective IT asset resource utilization, also known as data storage and computer server “sprawl,” is increasingly plaguing the modern IT data management landscape.

With advances in storage technology, there are different types of higher performance storage systems. For example, without loss of generality, these higher performance storage servers may be all-flash storage servers. While these types of storage server due offer higher performance, they are more expensive than previous generations of storage systems.

Storage administrators who want to improve their performance may choose to migrate their data to these higher performance storage systems. However, due to the increased cost associated with these higher performance storage systems, some storage administrators may prefer to only migrate some of their data and not all their data to these high-performance storage systems.

Another issue IT data management faces is outdated storage systems. Some storage administrators may face a recurring task to retire outdated storage systems in favor of new storage systems while migrating data from each old system to a new system.

Therefore, it would be desirable to provide a system and method that overcomes the above issues. The system and method would enable storage administrators to increase the performance of storage for data they want at higher performance for while decreasing the cost of data they want at lower cost. The system and method enable storage administrators to reduce the time required to make a new storage system the primary storage system.

### SUMMARY

In accordance with one embodiment, an electronic file storage system is disclosed. The electronic file storage system has a processor. A memory is coupled to the processor. The memory stores program instructions that when executed by the processor, causes the processor to: migrate files from a first storage system to a second storage system, wherein a first set of files are copied as completed files to the second storage system and a second set of files have symbolic links written on the second storage system directed to the second set of files stored on the first storage system.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a diagram of an exemplary electronic file migration system according to one aspect of the present application;

FIG. 2 is a simplified block diagram of an exemplary embodiment of a computing device/server depicted in FIG. 1 in accordance with one aspect of the present application;

FIG. 3 is an exemplary embodiment of the system of FIG. 1 migrating files and static symbolic links in accordance with an embodiment of the present invention;

FIG. 4 is an exemplary embodiment of the system of FIG. 1 migrating files and dynamic symbolic links in accordance with an embodiment of the present invention;

FIG. 5 is an exemplary embodiment of the system of FIG. 1 migrating files and dynamic symbolic links to a third storage system in accordance with an embodiment of the present invention;

FIG. 6 is an exemplary embodiment of the system of FIG. 1 with an intermediate state in migration of files and dynamic symbolic links to a third storage system in accordance with an embodiment of the present invention; and

FIG. 7 is an exemplary embodiment of the system of FIG. 1 migrating files and dynamic symbolic links to a third storage system from two storage systems in accordance with an embodiment of the present invention.

### DESCRIPTION OF THE APPLICATION

The description set forth below in connection with the appended drawings is intended as a description of presently preferred embodiments of the disclosure and is not intended to represent the only fours in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Specific embodiments of the invention may now be described in detail with reference to the accompanying figures. Like elements in the various figures may be denoted by like reference numerals for consistency.

In the following detailed description of embodiments of the invention, numerous specific details may be set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description may be presented largely in terms of description of shapes, configurations, and/or other symbolic representations that directly or indirectly resemble one or more novel electronic migration and storage systems and methods of operating such novel systems. These descriptions and representations may be the means used by those experienced or skilled in the art to most effectively convey the substance of their work to others skilled in the art.

Reference herein to “one embodiment” or “an embodiment” may mean that a particular feature, structure, or characteristic described in connection with the embodiment can be included in at least one embodiment of the invention. The appearances of the phrase “in one embodiment” in various places in the specification may not necessarily be all referring to the same embodiment. Furthermore, separate or alternative embodiments may not be necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing device,” and/or a “main computing device” may each be defined as electronic-circuit hardware device, such as a computer system, a computer server, a data storage unit, or another electronic-circuit hardware unit controlled, managed, and maintained by an analysis module, which is executed in a CPU and a memory unit of the electronic-circuit hardware device for the electronic file migration management.

In addition, for the purpose of describing the invention, a term “computer server” may be defined as a physical computer system, another hardware device, a software and/or hardware module executed in an electronic device, or a combination thereof. For example, in context of an embodiment of the invention, a “computer server” may be dedicated to executing one or more computer programs for creating, managing, and maintaining a robust and efficient metadata analysis and storage system. In a preferred embodiment of the invention, a computer server may be connected to one or more data networks, such as a local area network (LAN), a wide area network (WAN), a cellular network, and the Internet.

In accordance with one embodiment of the invention, an electronic file migration system may be disclosed. The electronic file migration system may migrate files from one storage system A to another storage system B, with each file being handled in one of two ways depending on a chosen policy. Files that are desired on the new storage system B may be copied to the new storage system B. Files that are not desired on the new storage system B may have symbolic links written on the new storage system B directly to the files on the old storage system A.

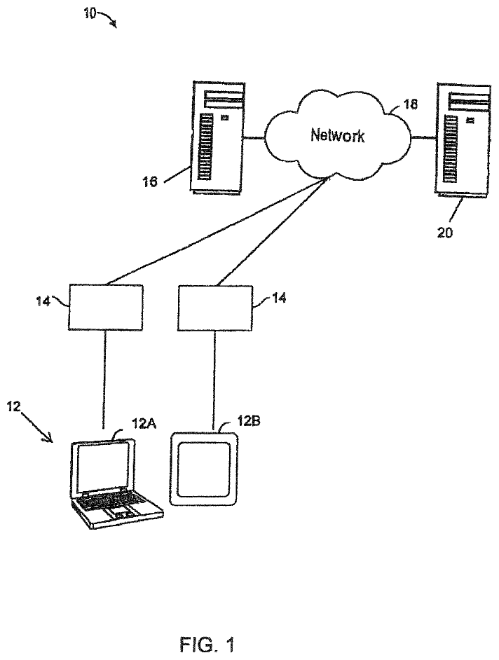

Referring to FIG. 1, an electronic file migration system 10 (hereinafter system 10) may be seen. The components of the system 10 may be coupled through wired or wireless connections.

The system may have one or more computing devices 12. The computing devices 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 12 may be described in the general context of computer system executable instructions, such as program modules, being executed by a computer system as may be described below. In the embodiment shown in FIG. 1, the computing device 12 may be seen as a desktop/laptop computing system 12A and a tablet device 12B. However, this should not be seen in a limiting manner as any computing device 12 described above may be used.

The computing devices 12 may be loaded with an operating system 14. The operating system 14 of the computing device 12 may manage hardware and software resources of the computing device 12 and provide common services for computer programs running on the computing device 12.

The computing devices 12 may be coupled to a server 16. The server 16 may be used to store data files, programs and the like for use by the computing devices 12. The computing devices 12 may be connected to the server 16 through a network 18. The network 18 may be a local area network (LAN), a general wide area network (WAN), wireless local area network (WLAN) and/or a public network. In accordance with one embodiment, the computing devices 12 may be connected to the server 16 through a network 18 which may be a LAN through wired or wireless connections.

The system 10 may have one or more servers 20. The servers 20 may be coupled to the server 16 and/or the computing devices 12 through the network 18. The network 18 may be a local area network (LAN), a general wide area network (WAN), wireless local area network (WLAN) and/or a public network. In accordance with one embodiment, the server 16 may be connected to the servers 20 through the network 18 which may be a WAN through wired or wireless connections.

The servers 20 may be used for migration and data back-up. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

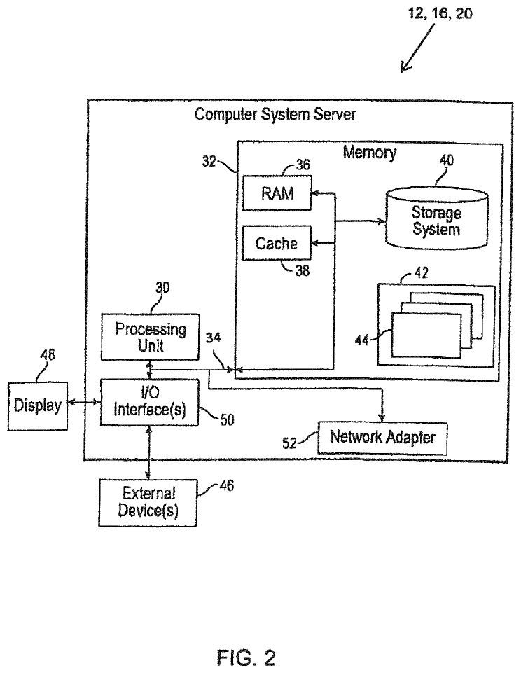

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

In accordance with one aspect of the present invention, the system 10 and the related method of operation may replicate the contents of one file server, physical volume, or file share—hereafter called the source—to another file server, physical volume, or file share—hereafter called the destination—by copying one set of source files as the files themselves and copying the complementary set of files only as symbolic links to the source files.

Without loss of generality, the set of source files that are copied as files may be those files that are more commonly accessed and the complementary set of source files that are copied as links may be those files that are less commonly accessed. The choice of files that are copied as files and files that are copied as links elsewhere in this description may refer to files more commonly accessed and less commonly accessed or may refer to files that are partitioned by any other metric.

The benefits of this embodiment of the present invention may be significant. Because the copy of the source to the destination does not need to copy the contents of all the files, it may be complete more quickly. And because the destination system is likely to be more performant and probably more expensive, the reduced size taken by the copy of the source may be less expensive while still giving virtually all of the performance improvements.

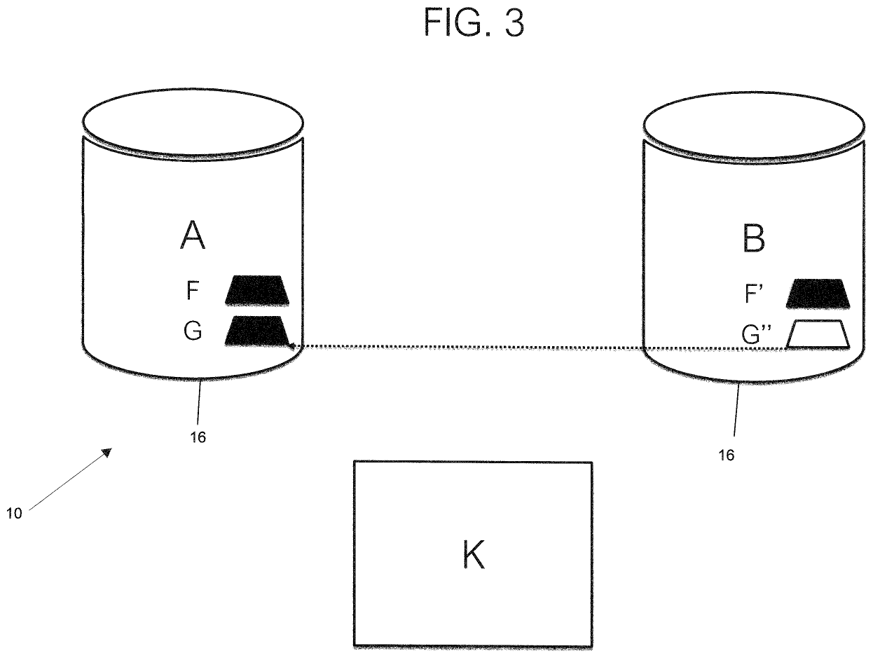

Referring to FIG. 3, the electronic file handling system 10 labeled K representing one embodiment of the invention may be seen. In this embodiment, two file servers 16, volumes, or shares may be seen. The file server 16 that may be the source is labeled A and the destination file server 16 may be labeled B. The system K copies an example file labeled F from source A to destination B as a complete file labeled F′. System K copies an example file labeled G from source A to destination B as a symbolic link labeled G″ referring back to source file G.

Following this pattern data migration system K copies every file on source A to destination B either as a complete file or as a symbolic link to the source file, depending on whether the access to the file on the destination should be immediate or if the tradeoff of access redirected by a symbolic link is acceptable based on the lower probability of access and the lower space occupied by the symbolic link. Files that are the same size or smaller than the size of the symbolic link that would refer to them may be copied as a whole in lieu of being linked.

In accordance with another embodiment of the present invention, the system 10 may copy files to the destination not by using a symbolic link to the original source file but rather by a dynamic symbolic link in the style of U.S. Pat. No. 10,198,447 which is hereby incorporated by reference in its entirety.

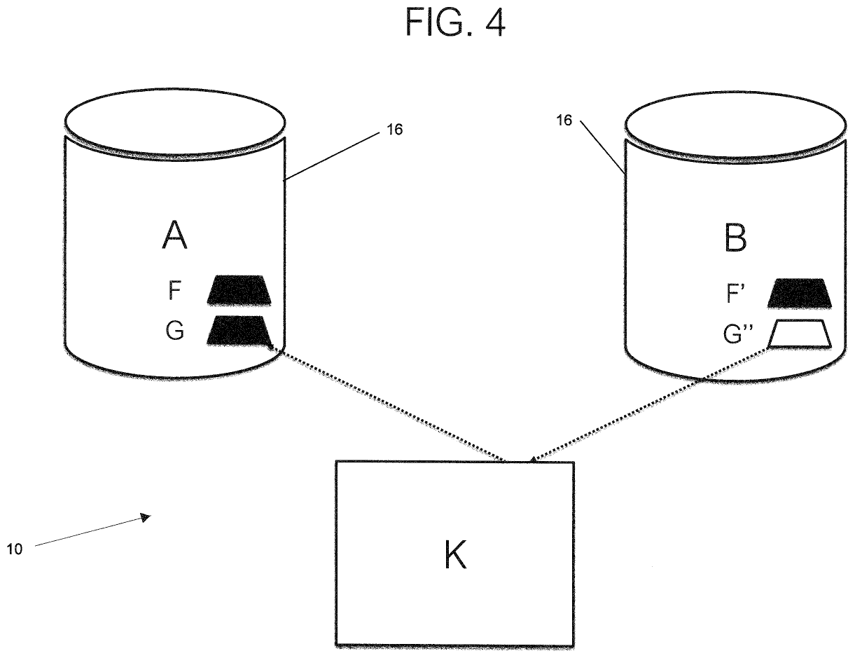

Referring to FIG. 4 the electronic file handling system 10 labeled K representing one embodiment of the invention may be seen. In this embodiment, two file servers 16, volumes, or shares may be seen. The file server 16 that may be the source is labeled A and the destination file server 16 may be labeled B. In this embodiment, the symbolic links written on destination B refer not to the original source files on source A, but rather to system K, which dynamically determines what file on source A is referred to by the redirected path in the symbolic link. The redirected path in the symbolic link may be isomorphic to the original path on source A, or it could be a reference to the file in some other form that system K dereferences in order to determine the original path on source A. System K may host a file system that services the file system requests for metadata and data by reading the file metadata and data from source A and delivering it in response to the file system requests.

In accordance with another embodiment of the present invention, the system 10 may copy files to the destination not by using a symbolic link to the original source file but rather by a dynamic symbolic link to an electronic file handling system in the style of U.S. Pat. No. 10,198,447. However, in this embodiment rather than servicing the file system requests itself, the system 10 may respond with another symbolic link to the original source file.

Another embodiment of the invention iteratively performs the same copy multiple times. The same copy may be done multiple times as long as files are found to be updated on the old storage system A, copying files that the policy newly qualifies for migration to the new storage system B whether copying them to the destination over earlier versions of the files or over symbolic links and whether copying them as complete files or as new symbolic links.

Another embodiment of the invention allows the administrator to retire the old storage system A when the migration iterations have run long enough. The time frame may be set for a predetermined time frame or at the administrator's discretion. At this point the new storage system B may become the primary storage system that users connect to and the old storage system A is no longer determined to be the primary storage system.

Another aspect of an embodiment of the present invention may continue to migrate files from the old storage system A to the new storage system B even after the new storage system B becomes the primary storage system. However, in this embodiment, the system 10 overwrites links that were previously copied as links with copies that are complete files. The files that were previously copied as links are again divided into two sets, one set of files that should be copied to storage system B as files and the complementary set that should remain copied to storage system B as links. The latter complementary set requires no action since they are already links. This can be repeated for a number of iterations until the desired files reside on storage system B, at which point the iterations can be stopped. This can furthermore be repeated until all files from storage system A are copied to storage system B and there are therefore no more links on storage system B referring to files on storage system A. At that time storage system B can be removed entirely from use.

This embodiment allows rapidly bringing the new storage system into service after the first set of desired files are copied to the new storage system as files, yet still copies all desired files to the new storage system in time. It furthermore allows the complete migration of the old storage system to the new storage system and retirement of the old storage system, but still using the new storage system as the primary storage system for most of the time required to do the complete storage system migration.

Another aspect of an embodiment of the present invention recognizes at system K a request for a link on storage system B that refers to the file on storage system A. After servicing that request, the system 10 may copy that file as a file from storage system A to storage system B, overwriting the link previously on storage system B.

Another aspect of an embodiment of the present invention deletes files from the source that are copied as complete files on the destination. Thus, there are between source and destination exactly one copy of the content and metadata of each file that was originally on the source, that being on the destination for copied complete files, and on the source for files linked to from the destination.

Another aspect of an embodiment of the present invention copies files to the destination by using a dynamic symbolic link to an electronic file handling system. The dynamic link may be in the style of U.S. Pat. No. 10,198,447 where the file contents and metadata may be stored on a third storage system in the style of Pat. No. 10,198,447.

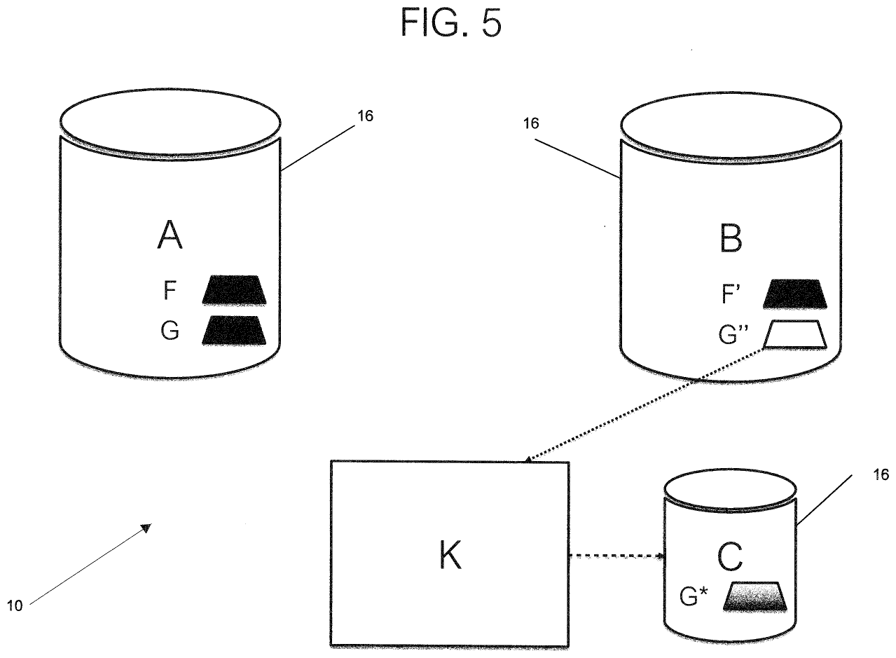

FIG. 5 shows the same two file servers 16 and electronic file handling system 10, labeled K of FIG. 4. In this embodiment, the symbolic links written on destination B refer to system K, which dynamically determines what file originally on source A is referred to by the redirected path to the symbolic link. System K may store the original files from the source that are not copied to the destination as complete files in the style of U.S. Pat. No. 10,198,447 in a third storage system labeled C.

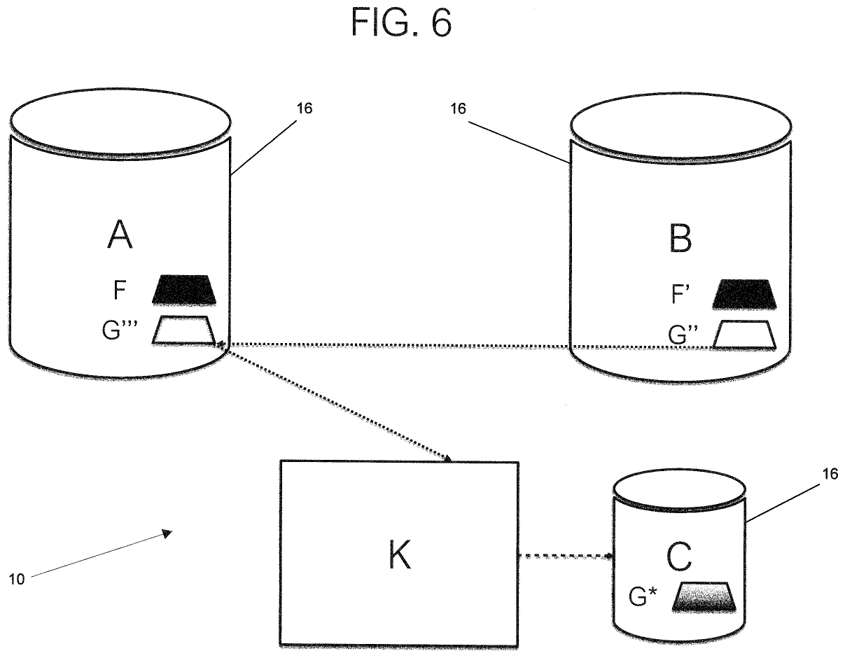

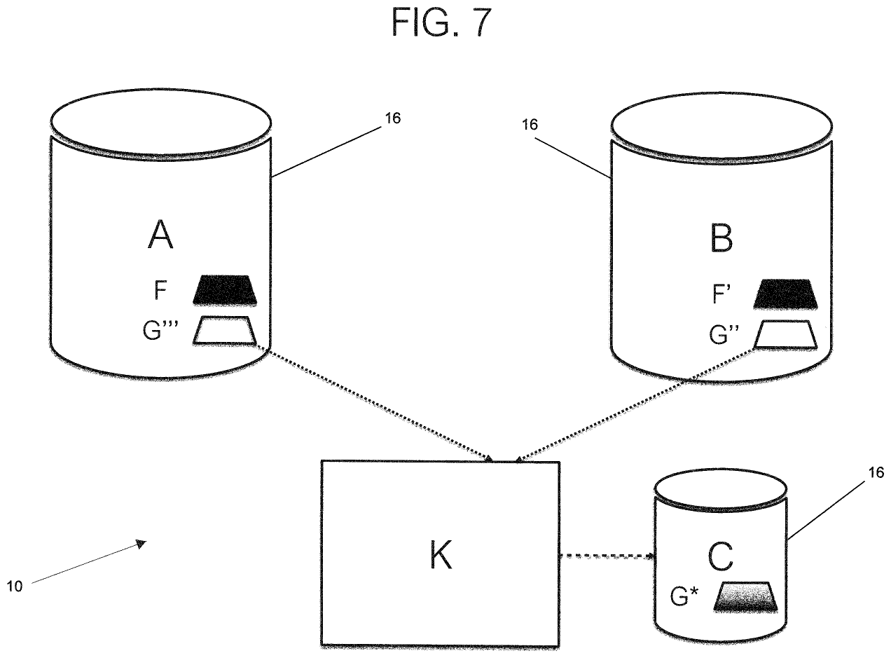

FIG. 6 shows a possible intermediate state of the migration in the event that the source files stored on source A are to be replaced by symbolic links on source A as they are copied by system K to be stored on storage system C. In this case file G may be copied as a link from source A to destination B and subsequently copied by system K in the style of U.S. Pat. No. 10,198,447. File G on source A may be replaced by a link to system K. For a time, until the link on destination B back to source A is replaced by a link to system K, the link on destination B actually refers to a link on source A that then refers to system K where the metadata and data reside. FIG. 7 shows the state of the migration after the link on destination B is replaced with the more direct link to system K.

Another aspect of an embodiment of the present invention deletes files from the source that were copied to the destination as symbolic links and retained as complete files on a third storage system in the style of U.S. Pat. No. 10,198,447.

In this embodiment, each file is copied either as a complete file to the destination or as a complete file to the third storage system referenced by a symbolic link on the destination. The files on the source are therefore no longer required as both those on the destination as complete files and those on the destination as symbolic links can be deleted from the source. The source can therefore be removed, and the destination can become the principal file storage device. This embodiment enables storing a smaller subset of files on a higher cost and higher performance storage device and storing the complementary subset of files on a lower cost and lower performance storage device, all while allowing the removal of the original storage device from use.

The present invention is very useful in providing migration of data from a storage system with expensive hardware, expensive backup requirements, and expensive management to a storage system with less expensive hardware, backup requirements, and hardware—all while making the migration transparent so the end user is not aware of it. Without loss of generality, the former storage system could be a network attached storage server and the latter could be cloud object storage, with very low backup and management costs due to its high durability. The present invention may use dynamic links in the style of U.S. Pat. No. 10,198,447 on a new storage system where those dynamic links are serviced by an intelligent migration platform that dynamically dereferences the dynamic link and delivers the file from an old storage system.

The foregoing description is illustrative of particular embodiments of the application, but is not meant to be a limitation upon the practice thereof. The following claims, including all equivalents thereof, are intended to define the scope of the application.

What is claimed is:

1. An electronic file migration storage system comprising:
a processor;
a memory coupled to the processor, the memory storing program instructions that when executed by the processor, causes the processor to:
migrate files from a first storage system to a second storage system, wherein a first set of files are copied as complete files to the second storage system and a second set of files have symbolic links written on the second storage system directed to the second set of files stored on the first storage system.

2. The electronic file migration system of claim 1, wherein the symbolic links are dynamic links serviced by an intelligent migration platform that dynamically dereferences the dynamic link and delivers the second set of files from the first storage system.

3. The electronic file migration system of claim 1, wherein the symbolic links are dynamic links directly delivering the second set of files from the first storage system.

4. The electronic file migration system of claim 1, wherein the memory storing program instructions that when executed by the processor, causes the processor to migrate the first set of files and the second set of files from the first storage system to the second storage system with repeated iterations.

5. The electronic file migration system of claim 4, wherein the memory storing program instructions that when executed by the processor, causes the processor to change a primary storage system available to users from the first storage system to the second storage system.

6. The electronic file migration system of claim 5, wherein the memory storing program instructions that when executed by the processor, causes the processor to migrate the first set of files and the second set of files from the first storage system to the second storage system with repeated iterations until desired files or all files have been migrated as completed files to the second storage system.

7. The electronic file migration system of claim 1, wherein the memory storing program instructions that when executed by the processor, causes the processor to overwrite links that were previously copied as links with copies that are complete files.

8. The electronic file migration system of claim 7, wherein the second set of files that were previously copied as links are divided into two sets, a first file set that are copied to the second storage system as completed files and a second file set remaining as links.

9. The electronic file migration system of claim 1, wherein the memory storing program instructions that when executed by the processor, causes the processor to delete the first set of files from the first storage system after the first set of files have been copied as completed files to the second storage system.

10. The electronic file migration system of claim 2, wherein the memory storing program instructions that when executed by the processor, causes the processor to:
migrate the second set of files still resident on the first storage system to a third storage system; and
replace the links on the second storage system with dynamic links serviced by the intelligent migration platform that dynamically dereferences the dynamic links and delivers the file from the third storage system.

11. The electronic file migration system of claim 10, wherein the memory storing program instructions that when executed by the processor, causes the processor to delete the files from the first storage system that are resident on the second storage system and on the third storage system.
